(19) United States
(12) Patent Application Publication
(10) Pub. No.: US 2015/0110308 A1
(43) Pub. Date: Apr. 23, 2015

(54) HANDHELD ELECTRONIC DEVICE

(71) Applicant: Acer Incorporated, New Taipei City (TW)

(72) Inventors: Kuei-Ting Tai, New Taipei City (TW); Jia-Ren Chang, New Taipei City (TW); Po-Jen Tu, New Taipei City (TW)

(73) Assignee: Acer Incorporated, New Taipei City (TW)

(21) Appl. No.: 14/197,230

(22) Filed: Mar. 5, 2014

(30) Foreign Application Priority Data
Oct. 23, 2013 (TW) 102138279

(51) Int. Cl. H04R 1/02; G06F 3/0354; H04R 1/32

(52) U.S. Cl. CPC H04R 1/028; H04R 1/323; G06F 3/03547; H04R 2499/15; H04R 2499/11
USPC 381/182; 381/388

(57) ABSTRACT

A handheld electronic device including a housing, at least one speaker and a touch display module is provided. The speaker and a touch display module are assembled to the housing. A channel is formed between the touch display module and the speaker, and a first sound is generated by the speaker and transmitted in the channel.

### CROSS-REFERENCE TO RELATED APPLICATION

This application claims the priority benefit of Taiwan application serial no. 102138279, filed on Oct. 23, 2013. The entirety of the above-mentioned patent application is hereby incorporated by reference herein and made a part of this specification.

### BACKGROUND

1. Technical Field

The invention relates to an electronic device. Particularly, the invention relates to a handheld electronic device.

2. Related Art

In recent years, along with development of technology, handheld electronic devices such as mobile phones, tablet computers, and e-books are gradually applied to people's daily life. The electronic devices are developed towards a design trend of convenience and multifunction, and when consumers purchase the electronic devices, the electronic devices having a slim border display surface have gradually become an important consideration factor in purchase besides software and hardware functions of the electronic devices.

The handheld electronic device is generally equipped with a speaker to play sounds. Taking the mobile phone as an example, in order to implement functions of phone calls and sound amplification, limited by the design structure of slim border, holes are generally formed on a surface of a cover glass of a touch panel so that the sounds produced by the speaker located under the cover glass can be transmitted out of the handheld electronic device through the holes. However, configuration of the holes increases production cost of the handheld electronic deice, and the appearance thereof does not cope with development of the slim border display surface.

### SUMMARY

The invention is directed to a handheld electronic device, which has a channel formed between a touch display module and a speaker, and sounds are transmitted through the channel.

The handheld electronic device of the invention includes a housing, at least one speaker and a touch display module. The speaker and the touch display module are assembled to the housing. A channel is formed between the touch display module and the speaker, and a first sound is generated by the speaker and transmitted to the channel.

According to the above descriptions, the channel of the invention is located between the touch display module and the speaker. Therefore, the sound generated by the speaker is transmitted to the channel to accordingly produce a derivative sound source at the channel, i.e. the channel can provide a resonant space and the sound is resonated in the channel, such that the whole channel is regarded as a source generation source to improve a sound generation range on the surface of the handheld electronic device, so as to overcome a structural limitation of the speaker when the handheld electronic device has the slim border design.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a perspective view of a handheld electronic device according to an embodiment of the invention.

FIG. 2 is a cross-sectional view of the handheld electronic device of FIG. 1 along a section line I-I.

FIG. 3 is a partial cross-sectional view of a handheld electronic device according to another embodiment of the invention.

FIG. 4 is a partial cross-sectional view of a handheld electronic device according to still another embodiment of the invention.

FIG. 5 is a diagram illustrating an orthogonal projection of a channel of FIG. 2 on a plane of a display component.

### DETAILED DESCRIPTION OF DISCLOSED EMBODIMENTS

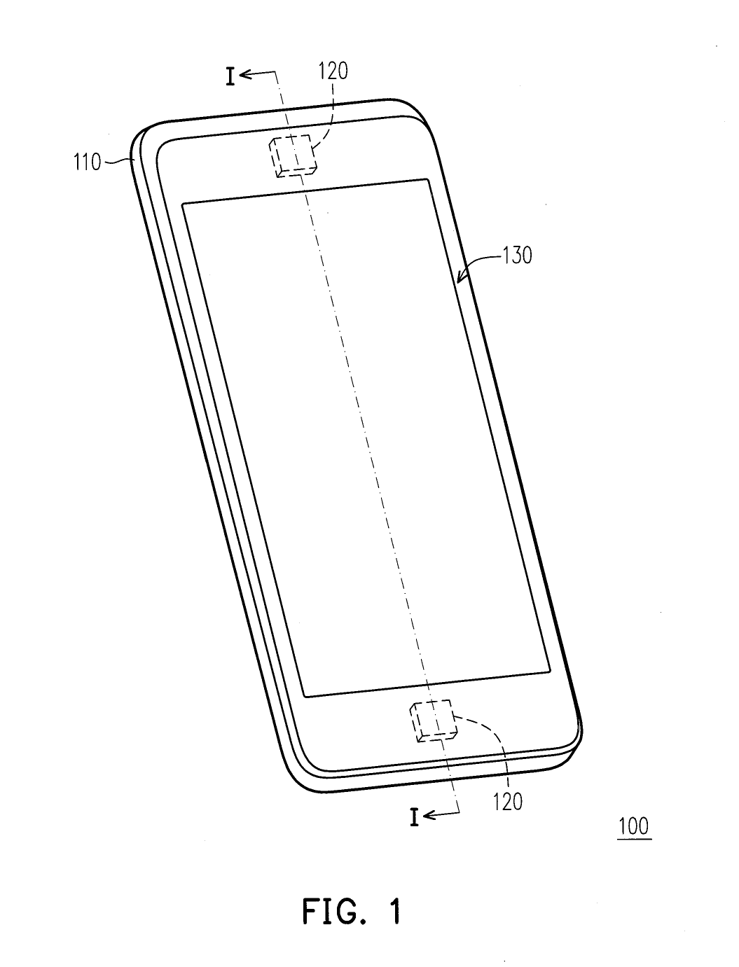

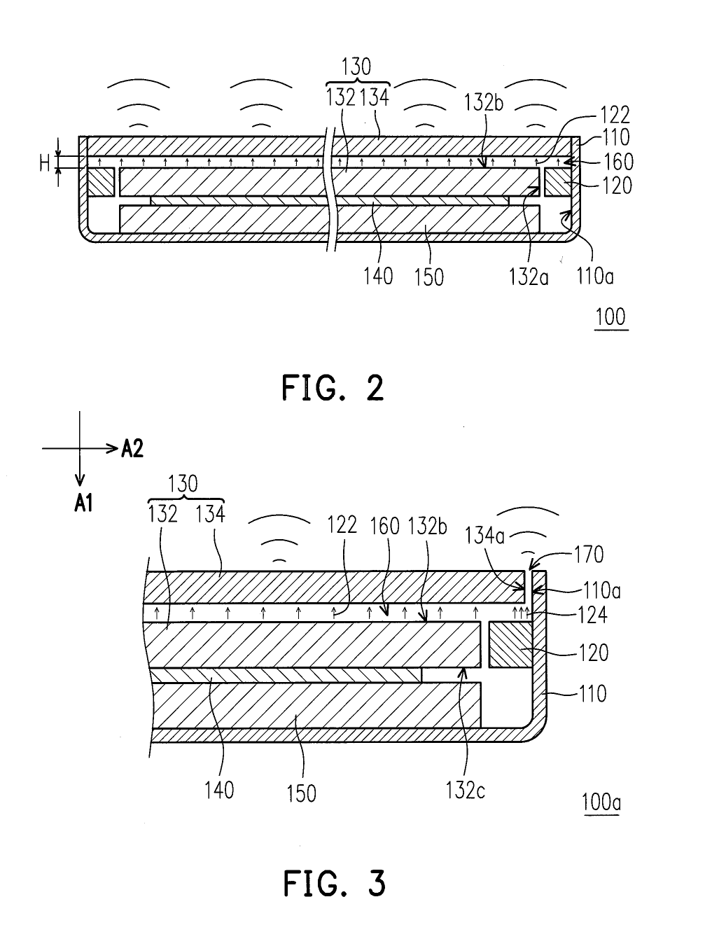

FIG. 1 is a perspective view of a handheld electronic device according to an embodiment of the invention. FIG. 2 is a cross-sectional view of the handheld electronic device of FIG. 1 along a section line I-I. Referring to FIG. 1 and FIG. 2, in the present embodiment, the handheld electronic device 100 includes a housing 110, at least one speaker 120 and a touch display module 130. The speaker 120 and the touch display module 130 are assembled to the housing 110. Moreover, the handheld electronic deice 100 is, for example, a mobile phone, a tablet PC or a e-book, etc., where the handheld electronic device 100 of the present embodiment is, for example, a mobile phone. It should be noticed that for clarity's sake, a proportion of the handheld electronic device of FIG. 2 is adjusted.

The touch display module 130 includes a display component 132 and a touch component 134. Further, the display component 132 of the present embodiment can be composed of a liquid crystal display (LCD) panel (not shown) and a backlight module (not shown), and the touch component 134 can be composed of a touch panel (not shown) and a transparent top cover (not shown). After the display component 132 and the touch component 134 are assembled to the housing 110, the display component 132 and the touch component 134 are electrically connected to a circuit board (for example, a motherboard) 140 under the display component 132, and a battery 150 is used to supply the required power.

Moreover, the touch component 134 is located above the display component 132 and the speaker 120, and a channel 160 is formed between the display component 132, the touch component 134 and the speaker 120, where the display component 132 and the speaker 120 are located at one side of the channel 160, and the touch component 134 is located at another side of the channel 160 opposite to the display component 132 and the speaker 120. When the speaker 120 generates a first sound 122, the first sound 122 can be transmitted to the channel 160, and is transmitted output of the housing 110 through the touch display module 130.

In detail, the channel 160 of the present embodiment is located in a sealed space within the housing 110, and a height H of the channel 160 is smaller than or equal to 1 mm. Moreover, a frequency of the first sound 122 transmitted to the channel 160 is smaller than 4 kHz. Namely, the first sound 122 of the present embodiment is a low frequency sound. Since the low frequency sound has an advantage of non-directivity, when the first sound 122 is transmitted to the channel 160, the channel 160 provides a resonant space required by the first sound 122, such that the channel 160 can be regarded as a source of the first sound 122, so as to expand a sounding range at a surface of the handheld electronic device 100. In other words, the first sound 122 can achieve a sounding effect through the whole channel 160, so as to overcome a structural limitation of the speaker 120 when the handheld electronic device 100 has a slim border design.

FIG. 3 is a partial cross-sectional view of a handheld electronic device according to another embodiment of the invention. Referring to FIG. 3, the handheld electronic device 100a of the present embodiment is similar to the handheld electronic device 100 of FIG. 2, where the same or similar referential numbers denote the same or similar devices, which are not repeated. In the present embodiment, a gap 170 is formed between a side surface 134a of the touch component 134 of the touch display module 130 and an inner wall surface 110a of the housing 110. The gap 170 extends along an extending direction of a first axis A1, and is perpendicular to the channel 160 extending along an extending direction of a second axis A2, and the gap 170 is communicated with the channel 160, where the extending direction of the first axis A1 is a normal direction of a display surface 132b of the display component 132.

Further, the speaker 120 further generates a second sound 124 with a frequency greater than 4 kHz, i.e. a high frequency sound. Since the high frequency sound has directivity, the second sound 124 is transmitted out of the housing 110 through the gap 170 adjacent to the speaker 120. Moreover, the aforementioned first sound 122 can also be transmitted out of the housing 110 through the gap 170. By configuring the gap 170, the touch display module 130 can achieve the effect of transmitting the second sound 124 and the first sound 122 without additionally configuring holes for transmitting the sounds. Moreover, since the handheld electronic device 100a does not configure the holes for transmitting sounds, manufacturing cost on the holes of the handheld electronic device 100a is decreased, and a shielding region (not shown) of the display surface 132b of the touch display module 130 is decreased to satisfy the design requirement of slim border.

Moreover, considering a size difference between the display component 132 and the touch component 134, a position of the speaker 120 can be adjusted to satisfy a space requirement of the touch display module 130 configured within the housing 110. As shown in FIG. 2 and FIG. 3, the speaker 120 is fixed to the inner wall surface 110a of the housing 110 and is located adjacent to the side surface 132a of the display component 132. Through such configuration, besides that the space requirement of the touch display module 130 is satisfied, a space formed above the speaker 120 can also be used to adjust the frequency of the first sound 122 and the frequency of the second sound 124.

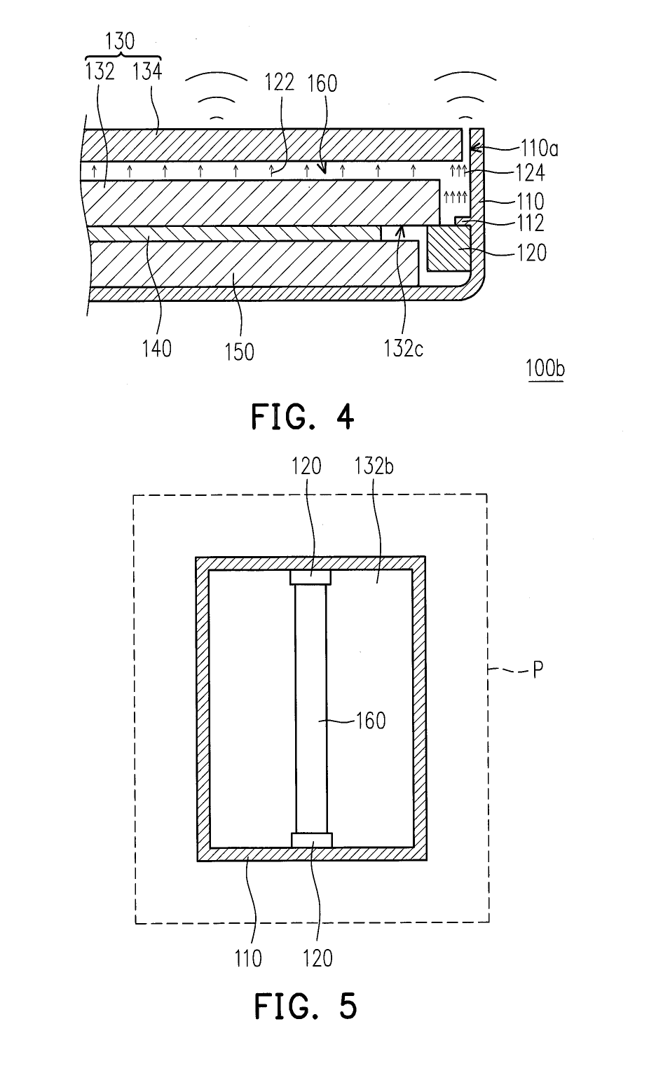

FIG. 4 is a partial cross-sectional view of a handheld electronic device according to still another embodiment of the invention. Referring to FIG. 4, the handheld electronic device 100b of the present embodiment is similar to the handheld electronic device 100a of FIG. 3, where the same or similar referential numbers denote the same or similar devices, which are not repeated. In the present embodiment, the speaker 120 is fixed to a retaining wall 112 of the housing 110 and is attached to a bottom surface 132c of the display component 132 away from the touch component 134. Therefore, a difference between the display component 132 of FIG. 4 and the display component 132 of FIG. 3 is that a size of the display component 132 of FIG. 4 is greater than a size of the display component 132 of FIG. 3, so as to provide a display effect larger than that of the handheld electronic device 100a of FIG. 3.

Referring to FIG. 1 and FIG. 2, the handheld electronic device 100 of the present embodiment includes a pair of the speakers 120, which are respectively disposed at two opposite ends of the display component 132, and the channel 160 is connected between the pair of speakers 120. In this way, regardless of how the user holds the handheld electronic device 100a, based on collaboration of a position sensor (or a G-sensor) and a control circuit and according to a sensing result thereof, one of the speakers 120 is selected to send sounds to cope with a listening habit of the user.

On the other hand, FIG. 5 is a diagram illustrating an orthogonal projection of the channel of FIG. 2 on a plane of the display component. In the present embodiment, an area of the orthogonal projection of the channel 160 on a plane P is smaller than or equal to that of the touch component 134, and the plane P is parallel to the display surface 132b of the display component 132. In the present embodiment, the channel 160 is respectively connected to the speakers 120, and the first sound 122 generated by the speaker 120 is sent out through the channel 160, such that even if the user's ear is not directly aligned to the gap 170, the user can still hear the first sound 122 transmitted through the channel 160 based on a layout of the channel 160 within the housing 110. Moreover, a type and configuration of the channel 160 within the housing 110 is not limited by the invention. In other words, in other embodiments that are not illustrated, a range of the channel 160 may cover the whole plane of the touch component 134, which is equivalent to a situation that the handheld electronic device 100 is capable of generating sound within a range covered by the touch component 134. Here, a designer can suitably configure the channel 160 according to a design requirement of the speakers 120, a usage environment and configuration of related components within the housing 110.

In summary, in the aforementioned embodiments of the invention, through the channel located between the touch display module and the speaker, i.e. the channel configured between the touch component, the display component and the speaker, when the speaker generates a low frequency sound, the sound can be transmitted through the channel, and is transmitted to external of the handheld electronic device through the touch display module. In this way, the channel can serve as a generation source of the sound to expand a sounding range on the surface of the handheld electronic deice, such that the handheld electronic device can satisfy the design requirement of slim border.

Moreover, the gap is formed between the touch display module and the housing, and the handheld electronic device can transmit out the high frequency and low frequency sounds generated by the speaker without additionally configuring sound holes, such that the manufacturing cost of the handheld electronic device is decreased. Meanwhile, since the sound holes are avoided to be configured on the surface of the touch display module, the blackened area of the display surface is decreased to cope with the design requirement of slim border of the handheld electronic device.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A handheld electronic device, comprising:
a housing;
at least one speaker, assembled to the housing; and
a touch display module, assembled to the housing, wherein a channel is formed between the touch display module and the speaker, and a first sound is generated by the speaker and transmitted to the channel.

2. The handheld electronic device as claimed in claim 1, wherein a frequency of the first sound is smaller than 4 kHz.

3. The handheld electronic device as claimed in claim 1, wherein the channel is located in a sealed space within the housing.

4. The handheld electronic device as claimed in claim 1, wherein a gap communicated with the channel is formed between the touch display module and the housing.

5. The handheld electronic device as claimed in claim 4, wherein the speaker generates a second sound, and the first sound and the second sound are transmitted out of the housing through the channel and the gap.

6. The handheld electronic device as claimed in claim 5, wherein a frequency of the second sound is greater than 4 kHz.

7. The handheld electronic device as claimed in claim 1, wherein the touch display module comprises:
a display component, assembled to the housing; and
a touch component, assembled to the housing, wherein a gap connected to the channel is formed between the touch component and the housing, the touch component is located above the display component and the speaker, the channel is located between the display component, the touch component and the speaker, wherein the display component and the speaker are located at one side of the channel, and the touch component is located at another side of the channel opposite to the display component and the speaker.

8. The handheld electronic device as claimed in claim 7, wherein the speaker is located adjacent to a side surface of the display component.

9. The handheld electronic device as claimed in claim 7, wherein the speaker is attached to a bottom surface of the display component away from the touch component.

10. The handheld electronic device as claimed in claim 7, further comprising a pair of speakers respectively located at two ends of the display component, wherein the channel is connected between the pair of speakers.

11. The handheld electronic device as claimed in claim 7, wherein an area of an orthogonal projection of the channel on a plane is smaller than or equal to an area of an orthogonal projection of the touch component on the plane, and the plane is parallel to a display surface of the display component.
